(19) United States
(12) Patent Application Publication
(10) Pub. No.: US 2026/0208160 A1
(43) Pub. Date: Jul. 23, 2026

(54) MEDIUM FOR QUANTITATIVELY REMOVING WATER FROM A GAS STREAM CONTAINING SULPHUR AND/OR SULPHUR-CONTAINING COMPOUNDS, DEVICE FOR THIS PURPOSE, AND USE OF SAID MEDIUM

(71) Applicant: Elementar Analysensysteme GmbH, Langenselbold (DE)

(72) Inventors: Jan HARTWIG, Alzenau (DE); Sabine KRAUS, Alzenau (DE)

(21) Appl. No.: 19/142,946

(22) PCT Filed: Nov. 28, 2023
(86) PCT No.: PCT/EP2023/082796

§ 371 Date: Jun. 24, 2025

(30) Foreign Application Priority Data
Jan. 31, 2023 (DE) 10 2023 102 324.1

(51) Int. Cl. B01J 20/32; B01J 20/04; B01J 20/08; B01J 20/28

(52) U.S. Cl. CPC B01J 20/3236; B01J 20/046; B01J 20/08; B01J 20/28019; B01J 20/28021; B01J 20/3204; B01J 2220/42; B01J 2220/4806; B01J 2220/49

(57) ABSTRACT

The invention relates to a material for the quantitative removal of water from a gas stream containing molecular sulphur and/or sulphur-containing compounds, in particular a gas stream supplied for gas analysis. This material contains at least 60% by weight of a granular carrier material which is inert to sulphur compounds, in particular sulphur dioxide, and between 5 and 35% by weight of magnesium perchlorate. The invention also comprises a device for purifying gas streams which is used with the material according to the invention and the use of the material in gas analysis.

The invention relates to a mixture for the quantitative removal of water from a gas stream containing sulphur and/or sulphur-containing compounds.

The removal of interfering components from gases in downstream process steps is of great importance in many processes. The removal of water is particularly important, as it is not only necessary for a large number of chemical syntheses, but also for most quantitative and/or qualitative analyses of gases. The analysis of gases requires the quantitative removal of the water contained, whereby the term “quantitative” in the sense of the invention is to be understood as meaning that the water content is reduced to a value of less than 100 ppm.

The need for such water removal applies in particular to all existing analysis modes and systems for the quantitative determination of oxygen, sulphur, nitrogen and/or carbon. In addition, water must be removed from the gas stream to be measured for TOC analysis and IRMS analysis in order to avoid interactions. Usually, in such a drying process, the gas stream to be analysed is passed through a pipe which is partially filled with the drying agent so that the gas has to pass through the drying agent and water is removed from it.

The desiccants used are phosphorus pentoxide-based agents known primarily under the name Sicapent®, whereby the phosphorus pentoxide is applied to an inert carrier material as the actual desiccant. On the other hand, magnesium perchlorate (Mg(ClO₄)₂) is mainly used in gas analysis. What both options have in common is that these desiccants are suitable for removing water quantitatively. The use of these materials therefore requires a high level of occupational safety and appropriate training for the personnel working with them. A further disadvantage of these materials is that their production is very time-consuming, energy-intensive and involves large amounts of waste.

Many other common desiccants are not suitable for actually removing water quantitatively and thus preparing the gas stream for quantitative analysis. Other desiccants which would in principle be suitable for quantitative water removal, in particular molecular sieves, do not behave inertly towards all gas streams, in particular they are not suitable for ensuring reproducible results with sulphur-containing gas streams, whereby sulphur-containing in the sense of the invention includes both the presence of sulphur and of sulphur-containing compounds. For example, side reactions often occur with the known drying agent silica gel, so that the analysis result is falsified by the pre-drying, since components in the drying agent are either bound or changed.

As already described, magnesium perchlorate is known from the literature as a possible drying agent. However, it has not yet been used in analysers because magnesium perchlorate dissolves in moisture and as a result can clog or damage the downstream analyser.

The invention is therefore based on the task of providing a simple and harmless material for the quantitative removal of water from a gas stream containing sulphur and/or sulphur-containing compounds, in particular sulphur dioxide (SO₂), which is also particularly suitable for drying a gas stream prior to a downstream gas analysis. For this purpose, the drying agent must not react or interact too strongly with the sample gases, as this would lead to a change in the measurement signal.

The highly acidic gas sulphur dioxide in particular poses a major challenge. This is particularly problematic because in elemental analysis, the sample material is first burned in the reactor and the resulting gas stream is then quantitatively analysed with regard to its components. During this combustion of the samples, SO₂ is always produced if sulphur and/or sulphur-containing compounds are present. This SO₂ is then detected so that the amount of sulphur contained in the original sample can be calculated. However, due to the interaction of SO₂ with almost all common drying agents, it is no longer possible to make reproducible quantitative statements regarding the sulphur content if the gas flow had to be dried beforehand. This applies in particular to measurements with a thermal conductivity detector (TCD), for which a dry gas flow is the basic prerequisite for precise, linear and repeatable results over the entire measuring range.

Despite these difficulties, the problem is solved with a material according to claim 1.

Such a material according to the invention comprises a mixture which contains a carrier material and magnesium perchlorate, wherein the proportion of the carrier material relative to the total mixture is at least 60 wt. %, preferably 70 to 80 wt. %, and that of the magnesium perchlorate is between 5 and 35 wt. %, preferably between 10 and 20 wt. %. The two components carrier material and magnesium perchlorate can be the only two components in the mixture and complement each other in terms of their proportions to 100% by weight, or other additives can also be provided.

Magnesium perchlorate is known as an inert drying material. By mixing it with the carrier material, preferably in a ratio of at least 1:2, preferably 1:3, it is possible to prevent the previously known disadvantage of clumping during the accumulation of water and, above all, the discharge of the material into downstream process steps or devices.

With regard to the carrier material, it is essential that it is inert to sulphur and sulphur-containing compounds, in particular sulphur dioxide. It has also proved to be favourable if the carrier material is manufactured in the form of spheres, hollow spheres or cylinders, as this allows the gas flow to pass through without excessive pressure losses. Hollow spheres with a diameter of 0.5-5.0 mm, preferably 1.0-3.0 mm, have proven to be particularly suitable for gas analysis systems, as the pressure loss can be minimised for the parameters of this application, in particular the flow velocities used.

In principle, any material that is inert with regard to sulphur and sulphur-containing compounds and is present in granulated form and is inert to the gases flowing through it in the application is suitable as a carrier material. Conceivable here are above all carrier materials such as those already known as carrier materials from heterogeneous catalysis, i.e. above all ceramic materials that behave inertly. This offers the advantage of being able to use existing and readily available granulates.

Alternatively, it has proven to be very favourable if the carrier material is corundum. Corundum is a relatively common mineral from the mineral class of aluminium oxides and hydroxides. It crystallises in the trigonal crystal system with the chemical composition Al2O3. Corundum is particularly suitable as a carrier material here, as it is not only resistant to high temperatures and has a high abrasion resistance due to the high hardness of the material but is also inert to almost all compounds. A reaction with sulphur-containing compounds, especially SO₂, can therefore be ruled out.

Another advantage of using corundum, especially hollow corundum spheres, is that the bulk densities of the individual components are close to each other. The material can therefore be produced and filled with simple mixing processes and does not segregate during transport.

A further preferred embodiment is that the carrier material is at least partially coated with the magnesium perchlorate, which can further reduce the risk of clumping. The coating can be applied with only parts of the magnesium perchlorate or with the entire amount.

Once again, the use of materials known from heterogeneous catalysis, such as zirconium oxide and, in some cases, particularly inert zeolites, is also suitable here, as these are usually coated with the catalyst and therefore have corresponding surfaces. The same advantages can also be found for the aluminium oxide corundum, which has a large surface area to which the gel that forms from the magnesium perchlorate in the presence of moisture adheres. This ensures that there is no clogging and flushing of liquid fractions inside the device, which could lead to the cancellation of measurements, premature replacement of the drying tube or damage to the device.

It has also proved to be favourable to add calcium chloride to the material, preferably in a quantity of 5 to 35% by weight, particularly preferably 5 to 10% by weight, as an additional drying agent. Calcium chloride is also inert to practically all gas flows to be measured. The addition can achieve primary drying and reduce the required proportion of magnesium perchlorate.

Additionally or alternatively, an indicator can be added to the mixture in order to recognise when the water absorption capacity of the drying agent is exhausted. The indicators used, which display a colour change depending on the moisture in the surrounding medium, can be inorganic and/or organic substances.

Inorganic indicators are often less expensive on the market. Among the inorganic indicators, the use of copper(II) sulphate (Cu(II)SO₄) is particularly favoured. Copper(ii) chloride can also be used. The advantage here is its harmlessness. When used together with calcium chloride, the colour changes from colourless to blue as soon as the primary drying agent, the molecular sieve, is no longer able to remove the water quantitatively.

Organic substances often show very clearly recognisable colour differences. Phenolphthalein is particularly suitable as an organic substance. Phenolphthalein has the particular advantage that it shows a colour change to white when the capacity of the molecular sieve, which is completely filled with water within its pores, is exhausted. In the course of the measurements, this “front” shifts further and further in the direction of flow towards the gas outlet. As soon as this colour change reaches the gas outlet, there is no longer a sufficient quantity of desiccant to completely remove the water. If, on the other hand, the mixture according to the invention is stored for a longer period of time in such a way that it is exposed to air humidity so that the water is not carried through a gas flow, this changes the reactions that lead to the colour change of the indicator. The indicator (In) then does not have the structure H₂In, which leads to an orange colour, but is present as In2- and thus turns white. This colour clearly shows that moisture has slowly diffused in. This also makes it easier to detect the cause of the depletion of a column's absorption capacity, in particular storage errors.

As mentioned, the use of pure calcium chloride as the sole drying agent would not be sufficient to ensure the quantitative removal of water, which is particularly important for gas analysis. Since calcium chloride also dissolves in water, it cannot be used as a carrier material. However, due to its colourless, non-transparent crystals, calcium chloride is well suited to making a clear colour change visible if the calcium chloride contains an indicator. Due to calcium chloride's ability to absorb large quantities of water and then dissolve in the water of crystallisation, the colour change is particularly visible when exposed to water. The indicator thus allows the optical traceability of water absorption.

Furthermore, the calcium chloride (CaCl₂)) containing the indicator can be coated with the indicator so that it lies on the surface of the calcium chloride, which acts as a carrier material. The application to magnesium perchlorate, on the other hand, is significantly more complex than the comparatively simple coating of calcium chloride. In a particularly preferred embodiment, the calcium chloride is therefore coated with at least one indicator. Alternatively, it is also possible to mix the indicator with the calcium chloride and form it into granules or beads, for example by pressing. The latter is less complex to produce than the aforementioned coating, but the colour change is sometimes more visible with a coating due to the higher local concentration on the surface, depending on the type of indicator used.

Furthermore, the use of calcium chloride as a carrier for the indicator also has the advantage that, as already mentioned, calcium chloride acts as a drying agent and therefore the introduction of an indicator on a carrier material does not lead to a dilution of the drying material itself. This in turn means that the total quantity of mixtures can remain the same in comparison to material with an indicator and material without an indicator, which plays a role in pressure loss, dead volume or service life, among other things.

In summary, the advantage of the new invention is to provide a way to use a new desiccant for C, N, S and O determinations in the presence of sulphur using simple chemicals available in large volumes, which simultaneously indicates the depletion of the desiccant. The hazard potential of the material has also been significantly reduced, making it safer and easier to process, supply and use. Thanks to the very good absorption capacity per volume, it was possible to maintain the operating time with the same container volume.

On the one hand, this ensures highly efficient drying even with any form of sulphur contained and, at the same time, a clearly visible colour change when the drying capacity is exhausted.

The invention also comprises a device for drying gases in the sense of a quantitative removal of water, in particular in preparation of a gas stream for subsequent analysis. Such a device has a gas-tight housing and a gas inlet and a gas outlet. The volume defined by this housing is at least partially filled with the material according to the invention according to at least one of claims 1 to 10. The material according to the invention can be used directly in any gas analysis, in particular in any elemental analysis, without modifying the system. A filled tubular reactor is a particularly simple embodiment of such a device.

In principle, the device can be made of any material that is inert and gas-tight with respect to the gas flow to be analysed. It must also be at least partially transparent. Metals, glass and plastic are conceivable base materials. If metals and non-transparent plastics are used, a viewing window made of glass or a corresponding transparent plastic must be provided so that the indicator turns over and the exhaustion of the service life of the desiccant is visible. In particular, glass and sometimes plastic as the base material has the advantage that such viewing windows are not necessary. When moving a colour change over the length of the container, especially the tube, this has the advantage that the effect is clearly visible. Glass is particularly favoured as a housing material due to its inert properties.

In principle, it is also conceivable to fill the device according to the invention sequentially with a series of materials, for example to first provide the flow direction with a carbon dioxide-absorbing material and then the drying agent according to the invention from the mixture.

Finally, the invention is also directed to the use of the material according to the invention according to any one of claims 1 to 10 and/or an apparatus according to the invention according to claim 11 or 12 for the quantitative removal of water in a gas analysis system. In particular, this relates to gas analysis systems for the determination of nitrogen, carbon, hydrogen, sulphur and oxygen (CHNSO). The material according to the invention is particularly suitable for completely removing water from the gas flow head without changing the flow behaviour and at the same time reliably indicates the exhaustion of its drying capacity due to the indicator it contains. The use of the material is not limited to specific devices but can be used in all applications that identify non-acidic, dry gas flows. Other conceivable areas of analysis include TOC analysis and IRMS analysis. A dry gas flow is also the basic prerequisite for precise, linear and repeatable results over the entire measuring range for a thermal conductivity detector WLD.

Further embodiments of the invention are shown in the examples and the figures and their associated description. Each feature is to be regarded as disclosed individually or in any combination. Some of the figures are slightly simplified and schematic.

It shows:

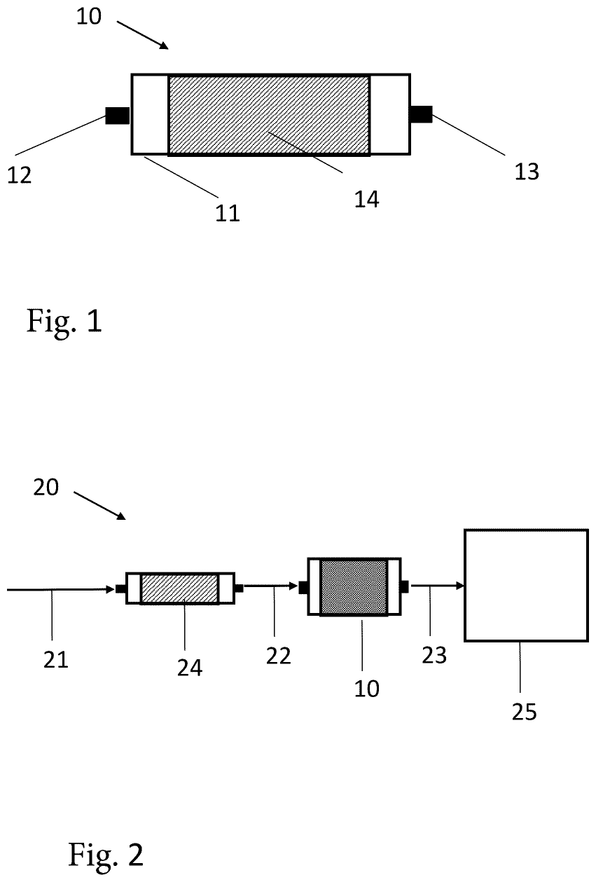

FIG. 1: a schematic embodiment of a device according to the invention and

FIG. 2: a schematic diagram of the use of a device according to the invention in a gas analysis system

FIG. 1 shows the device 10 according to the invention, which is designed as a preferably cylindrical housing 11 with a gas inlet 12 and a gas outlet 13. Inside there is a filling 14 with the material according to the invention, which is inserted in such a way that the gas flow flowing in through the gas inlet 12 must pass through the material in any case before it can escape via the gas outlet 13.

FIG. 2 shows a very simplified gas analysis system 20, preferably an elemental analysis system, in which the material according to the invention is used for the quantitative removal of water. Via lines 21, 22 and 23, the gas flow is first passed through a device for removing carbon dioxide 24 and then through a device 10 according to the invention before it is analysed in the detector 25.

As an alternative to the graphical representation, the functions of the devices 24 and 10, i.e. carbon dioxide removal and drying, can also be arranged in a device in such a way that this device has two segments into which a corresponding material is filled. In particular, this may be a tube which is filled with the mixture according to the invention in a first part and with a drying agent in a second part downstream with respect to the flowing gas stream.

In addition, an undisplayed pre-drying process can be provided before the removal of carbon dioxide.

### EXAMPLE 1

The following example shows how many measurements can be carried out with which type of absorbent for the quantitative removal of water before the indicator contained in each case indicates a complete loading with water. The values given are average values over 3 service life tests in each case.

| | Number of measurements |
|---|---|
| Drying material | (service life) |
| Sicapent ® | 107 |
| Mixture according to the invention | 121 |

The following example shows that due to the very good drying properties, the service life of a column can at least be maintained.

### LIST OF REFERENCE SIGNS

10 device
11 housing
12 Gas inlet
13 Gas outlet
14 filling with the material according to the invention
20 gas analysis system
21-23 line
24 device
25 detector

1. Material for the quantitative removal of water from a gas stream containing molecular sulphur and/or sulphur-containing compounds, characterised in that the material contains at least 60% by weight of a carrier material designed as granules, which behaves inertly towards sulphur and sulphur-containing compounds, and between 5 and 35% by weight of magnesium perchlorate, characterised in that the material additionally contains calcium chloride and the proportion of calcium chloride is between 5 and 35% by weight.

2. Material for the quantitative removal of water from a gas stream containing molecular sulphur and/or sulphur-containing compounds according to claim 1, characterised in that the granulated carrier material at least partially comprises granules in the form of spheres, hollow spheres and/or cylinders.

3. Material for the quantitative removal of water from a gas stream containing molecular sulphur and/or sulphur-containing compounds according to claim 1, characterised in that the carrier material is a ceramic material or corundum.

4. Material for the quantitative removal of water from a gas stream containing molecular sulphur and/or sulphur-containing compounds according to claim 1, characterised in that the carrier material is at least partially coated with at least parts of the magnesium perchlorate.

5. Material for the quantitative removal of water from a gas stream containing molecular sulphur and/or sulphur-containing compounds according to claim 1, characterised in that the material additionally contains an indicator.

6. Material for the quantitative removal of water from a gas stream containing molecular sulphur and/or sulphur-containing compounds according to claim 5, characterised in that the indicator is an inorganic compound, in particular copper (II) sulphate.

7. Material for the quantitative removal of water from a gas stream containing molecular sulphur and/or sulphur-containing compounds according to claim 5, characterised in that the indicator is an organic compound, in particular phenolphthalein.

8. Material for the quantitative removal of water from a gas stream containing molecular sulphur and/or sulphur-containing compounds according to claim 1, characterised in that the calcium chloride is at least partially coated with the indicator or calcium chloride and indicator are present together in granules.

9. Device (10) for absorbing water with a gas-tight housing (11) which has a gas inlet (12) and a gas outlet (13) and whose volume is at least partially filled with a material according to claim 1.

10. Device (10) according to claim 9, characterised in that the housing is at least partially transparent.

11. Use of a material for the quantitative removal of water from a gas stream containing molecular sulphur and/or sulphur-containing compounds in a gas analysis system (20) for the determination of nitrogen, carbon, hydrogen and/or oxygen, wherein the material contains at least 60% by weight of a carrier material designed as granules, which behaves inertly towards sulphur and sulphur-containing compounds, and between 5 and 35% by weight of magnesium perchlorate.

12. Use of a material for the quantitative removal of water from a gas stream containing molecular sulphur and/or sulphur-containing compounds in a TOC analysis or an IRMS analysis, wherein the material contains at least 60% by weight of a granular carrier material which is inert to sulphur and sulphur-containing compounds, and between 5 and 35% by weight of magnesium perchlorate.
